(19) United States
(12) Patent Application Publication
(10) Pub. No.: US 2026/0080681 A1
(43) Pub. Date: Mar. 19, 2026

(54) SYSTEMS AND METHODS FOR VIDEO-LANGUAGE NEURAL NETWORKS

(71) Applicant: Salesforce, Inc., San Francisco, CA (US)

(72) Inventors: Michael S. Ryoo, New York, NY (US); Honglu Zhou, Palo Alto, CA (US); Shrikant Kendre, Palo Alto, CA (US); Can Qin, Somerville, MA (US); Le Xue, Mountain View, CA (US); Manli Shu, Greenbelt, MD (US); Silvio Savarese, Palo Alto, CA (US); Ran Xu, Mountain View, CA (US); Caiming Xiong, Menlo Park, CA (US); Juan Carlos Niebles Duque, Mountain View, CA (US)

(21) Appl. No.: 19/041,811

(22) Filed: Jan. 30, 2025

Related U.S. Application Data
(60) Provisional application No. 63/695,778, filed on Sep. 17, 2024.

(51) Int. Cl. G06V 20/40; G06F 40/40; G06N 3/084; G06V 10/778; G06V 10/82

(52) U.S. Cl. CPC G06V 20/41; G06F 40/40; G06N 3/084; G06V 10/778; G06V 10/82; G06V 20/46

(57) ABSTRACT

Embodiments described herein provide a vision-language neural network framework that outputs a text response to a user text query relating to the media content of the video input. Specifically, the vision-language neural network may comprise (1) a vision encoder (ViT) transforming each frame input from the video input into a set of tokens, (2) a frame-level tokenizer to reduce the number of tokens, (3) a temporal encoder to build video-level token representations, and (4) an autoregressive LLM generating a text output based on such video tokens and text prompt tokens.

### CROSS REFERENCE(S)

The application is s nonprovisional of and claims priority under 35 U.S.C. 119 to U.S. provisional application No. 63/695,778, filed Sep. 17, 2024, which is hereby expressly incorporated by reference herein in its entirety.

### TECHNICAL FIELD

The embodiments relate generally to machine learning systems for multimodal models, and more specifically to the video-language neural networks.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues.

Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Some AI agents may generate a response to different types of user utterances. For example, in autonomous driving or other navigational, surveillance systems, an AI agent may intake a user query and input visual data such as a live video stream of the surrounding, and the user query describes a task request relating to the live video stream, e.g., to analyze the video content, to answer a question based on the visual data, and/or the like. Such AI agents may employ Large Multimodal Models (LMMs) to make predictions (e.g., an output text) based on multimodal inputs (e.g., text and images). Existing LMMs mostly employ intricate architectures to bridge vision and language modalities, and often require complex training objectives. Specifically, existing LMMs often use a large number of tokens for video (e.g., thousands even for 8 frames). For longer videos, the number of video tokens can be significant. Thus, large-scale training of such LMMs can be computationally expensive and time-consuming, thus rendering the LMM less scalable.

### BRIEF DESCRIPTION OF THE DRAWINGS

FIG. 1 is a simplified diagram illustrating an example use case of a LMM agent generating a response to a surveillance video, according to embodiments described herein.

FIG. 2 is a simplified diagram illustrating an example architecture of a multimodal model framework for LMM shown in FIG. 1, according to some embodiments.

FIGS. 3A-3D are simplified diagrams illustrating various forms of the temporal encoder, according to embodiments described herein.

FIG. 4 is a simplified diagram illustrating a computing device implementing the multimodal model framework described in FIG. 1, according to one embodiment described herein.

FIG. 5 is a simplified diagram illustrating a neural network structure, according to some embodiments.

FIG. 6 is a simplified block diagram of a networked system suitable for implementing the multimodal model framework described in FIGS. 1-5 and other embodiments described herein.

FIG. 7 is an example logic flow diagram illustrating a method of perform a vision-language task by a neural network multimodal model in response to an input video shown in FIGS. 1-6, according to some embodiments described herein.

FIG. 8 is an example logic flow diagram illustrating a method of training the neural network multimodal model to perform a video-language task shown in FIGS. 1-6, in response to multiple input images, according to some embodiments described herein

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

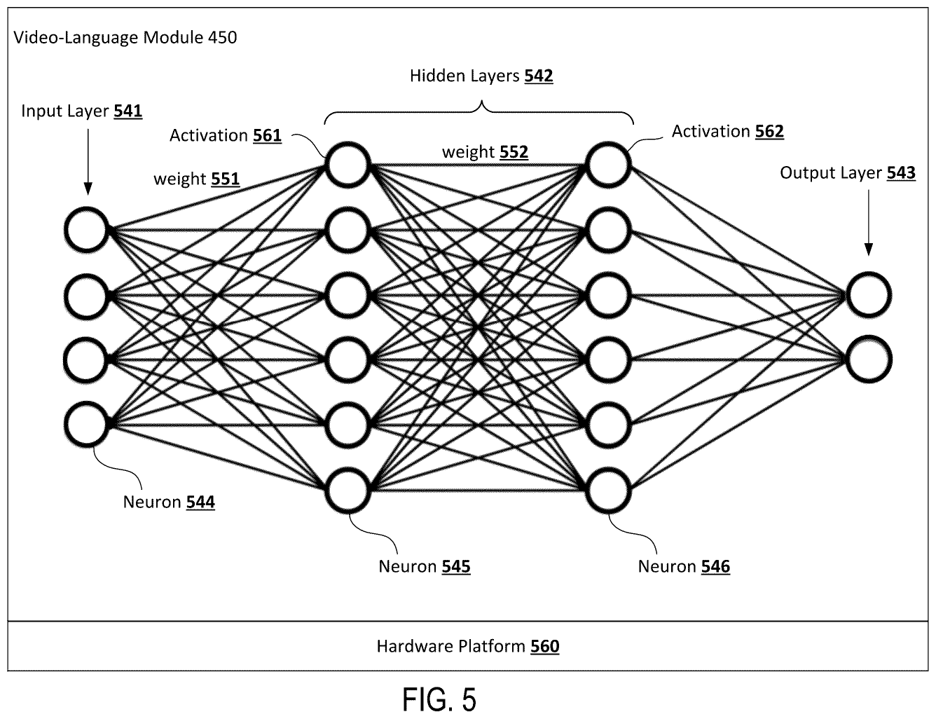

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

In view of the need for an AI system to process and generate a response to a video input, embodiments described herein provide a vision-language neural network framework that outputs a text response to a user text query relating to the media content of the video input. Specifically, the vision-language neural network may comprise (1) a vision encoder (ViT) transforming each frame input from the video input into a set of tokens, (2) a frame-level tokenizer to reduce the number of tokens, (3) a temporal encoder to build video-level token representations, and (4) an autoregressive LLM generating a text output based on such video tokens and text prompt tokens.

In this way, while the temporal encoder abstracts frame/image-level visual tokens into much fewer video-level visual tokens in a systematic way, efficiency of processing video content is much improved, resulting in a “light” vision language model. Such improved processing efficiency also improves hardware requirements such as fewer processing time, and memory use. Neural network technology in video processing is thus improved.

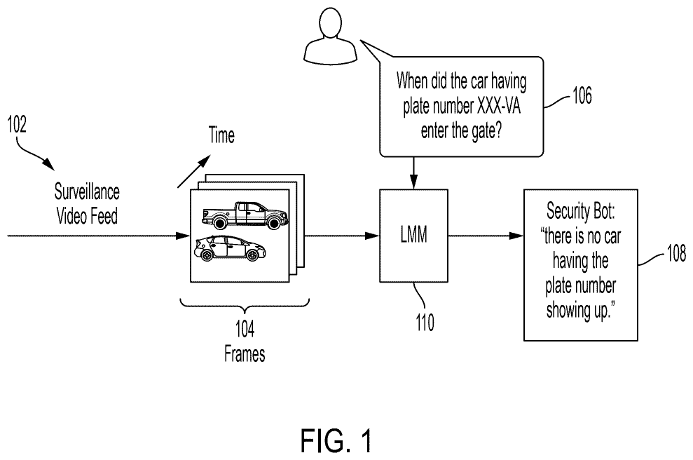

FIG. 1 is a simplified diagram illustrating an example use case of a LMM agent generating a response to a surveillance video, according to embodiments described herein. For example, as shown in FIG. 1, LMM 110 may be used to build an AI agent to process surveillance video feeds 102 and answer user queries 106 about specific events based on the video content of the input video feed 102, such as identifying when a car with a specified license plate entered a gate. For example, the video feed 102 and/or a video file may be sampled into a plurality of video frames 104. The LMM 110 may receive a series of video frames 104 and a text user query 106, and in turn generate a text response 108 based on the image and text inputs.

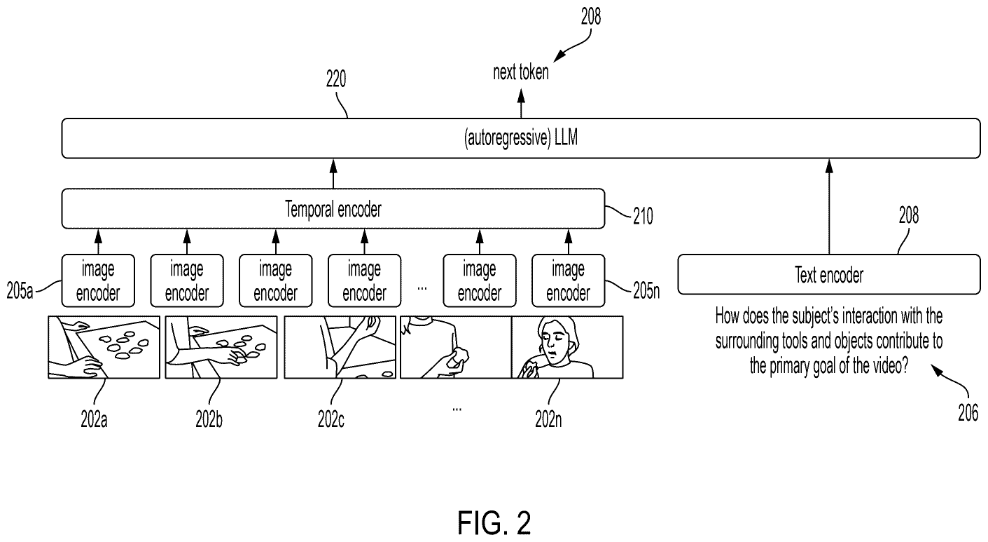

FIG. 2 is a simplified diagram illustrating an example architecture of a multimodal model framework for LMM 110 shown in FIG. 1, according to some embodiments. For example, the LMM framework 110 may comprise one or more image encoders 205a-205n transforming each frame input 202a-n from the video input (e.g., 102 in FIG. 1) into a set of tokens, a temporal encoder 210 to generate video-level token representations from encoded video tokens from the image encoders 2-5a-n, a text encoder 208 encoding a text user input (prompt) 206 into text token representations, and an autoregressive LLM 220 predicting a next token 208 to form a text output (e.g., 108 in FIG. 1) based on such video token representations and the text token representations from text encoder 208.

In one embodiment, each image encoder 205a-n may comprise a vision Transformer (ViT) encoder. The VIT encoder may be a pre-trained ViT-H-14 that takes one single image frame at a time. The output form the VIT encoders 205a-n may be downsampled by a Perceiver-Resampler to map such visual tokens into N=128 visual tokens per frame, independently. For example, a Perceiver-Resampler may adapt the high-dimensional visual tokens from image encoders 205a-n to a fixed-size (e.g., N=128) learnable latent representation. A cross-attention mechanism at the Resampler may use the learnable latent queries to the high-dimensional input visual tokens. Each latent query gathers relevant information from the input visual tokens based on attention weights. In this way, fixed-size latent representation may be computed as a weighted sum of the input tokens, with the attention weights. The latent representation thus summarizes the input data resulting in a lower dimensional representation.

After the visual tokens over time (i.e., over multiple frames in the video) are obtained, they are provided to the temporal encoder 210 that builds a video-level token representation from such sequence of image-level tokens. The temporal encoder 210 serves as a mapping function between a set of N×T image tokens to M video tokens where T is the number of frames and M is a constant number of tokens. For example, video frames 202a-n may each be independently encoded into visual tokens at image encoders 205a-n, but video content from video frames 202a-n may overlap as they have been sequentially sampled from the same video. The temporal encoder 210 may extract such correlations between video frames 205a-n along the time axis, e.g., temporal information, and thus compress the token representations of video frames 202a-n in a compact manner.

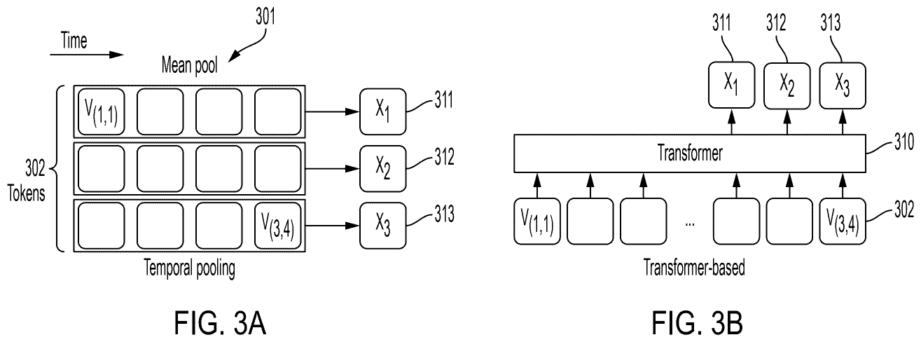

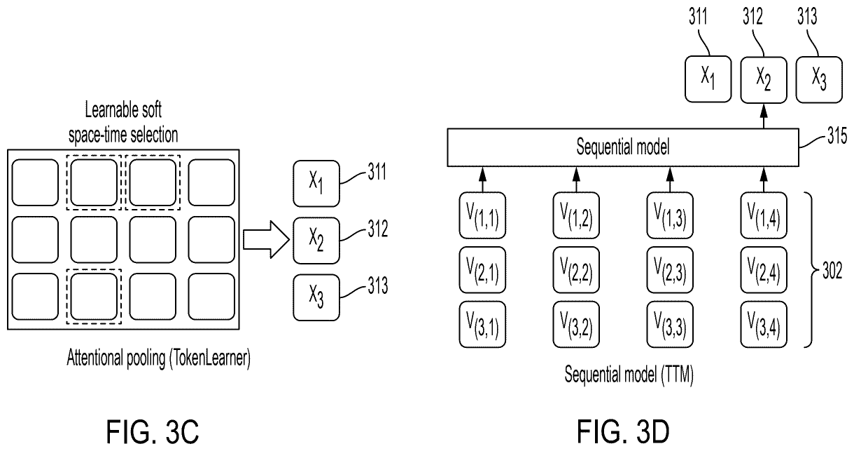

In one embodiment, the temporal encoder 210 is a function of tokens, taking N·T image tokens as an input and returning M tokens as an output: x_{1, . . . , M}=ƒ(v_{(1,1), . . . , (N,T)}). FIGS. 3A-3D are simplified diagrams illustrating various forms of the temporal encoder 210, according to embodiments described herein. For example, temporal encoder 210 may apply temporal max pooling (FIG. 3A), Transformer based (FIG. 3B), attention pooling (FIG. 3C), sequential models (FIG. 3D) and/or the like.

As shown in FIG. 3A, the temporal encoder 210 may apply temporal pooling, e.g., output tokens 311, 312, 313 are generated by summating per-frame tokens 302 over time and/or taking an average (mean pool 301):

$${x}_{1 , ... , M} = {\{ {\sum }_{t} ( {v}_{( i , t )} ) \}}_{i = 1}^{M}$$

where M is restricted to be identical to N.

As shown in FIG. 3B, a temporal Transformer 310 may be used to model the entire token sequence 302 and select the last m tokens as output tokens 311, 312 and 313:

$${x}_{1 , ... , M} = {\{ Transformer ( v ) \}}_{N \cdot T - M + 1}^{N \cdot T}$$

As shown in FIG. 3C, the temporal encoder 210 may apply spatio-temporal attentional pooling. For example, attentional pooling may allow a learnable ‘soft selection’ of multiple tokens 311, 312, 313 given a larger set of input tokens over space and time. The selection of the multiple tokens 311, 312, 313 may be updated during training so as to select tokens that best represent the NT image tokens. Specifically, a Token Learner may serve as the space-time aware temporal encoder 210. Unlike previous per-image-frame usage of poolings where spatial pooling and temporal pooling are applied separately (e.g., Video-ChatGPT), the temporal encoder 210 directly takes all N·T tokens and ‘learns’ to soft-select M informative tokens spatio-temporally. Here, N tokens could be viewed as spatial representations of a frame and T of them may be selected, suggesting the selected tokens are a spatio-temporal representation selection. Therefore, the attentional pooling may be expressed as:

$${x}_{i} = A ( V ) \cdot V = soft max ( α ( {V}^{T} ) ) \cdot V$$

where Vis a matrix formed by concatenating input tokens v_{(1,1), . . . , (N,T)}. The function A(^{⋅}) computes the summation weights for V, performing soft selection of tokens. This is further decomposed to the softmax and the function α(^{⋅}). In Perceiver, a matrix multiplication with a latent query tokens (i.e., cross attention where |Q|=m) have been used to implement this: α(V)=QV^{T}/c. Token Learner uses a convolution/MLP on top of V: α(V)=MLPₘ(V^{T}), which allows selecting a smaller number of tokens (e.g., M=32 tokens).

As shown in FIG. 3D, the temporal encoder 210 may be a Token Turing Machines (TTM), which is a sequential model 315 taking any number of frames in the form of a sequence of image tokens 302 to generate a video-level token representation of tokens 311, 312, 313 (e.g., M=128 tokens regardless the number of frames). The TTM may be extended by adding time-stamped positional encodings to embed the frame index of each token in the latent space. This enables the tokens in the ‘memory’ of TTM to preserve the temporal ordering information, which is crucial when representing complicated or long video scenes. In addition, the TTM temporal encoder 210 may be operated in a ‘grouped’ fashion, maintaining a separate memory of size G=4 for each of N=128 tokens over time. The memory is maintained to have the size is N·G, and the final output from the sequence model is attentionally pooled from the final memory to give M tokens.

With reference back to FIG. 2, in one embodiment, a text encoder 208 may encode a text query (e.g., from a user) 206 into text tokens. The resulting text tokens, together with video-level tokens from the temporal encoder 210 are given to the LLM together with the encoded text tokens to LLM 220, which in turn predicts a next token 208 to form output text sentences.

For example, to achieve computational efficiency, the LMM 110 may take uniformly sampled 8 frames (images 202a-n) per video. As a result, image encoders 205a-n may first map a video into 8×729 visual tokens, which is then down-sampled to 8×128 visual tokens using Perceiver-Resampler, and then to 16˜128 video tokens using the temporal encoder 210.

### Computer and Network Environment

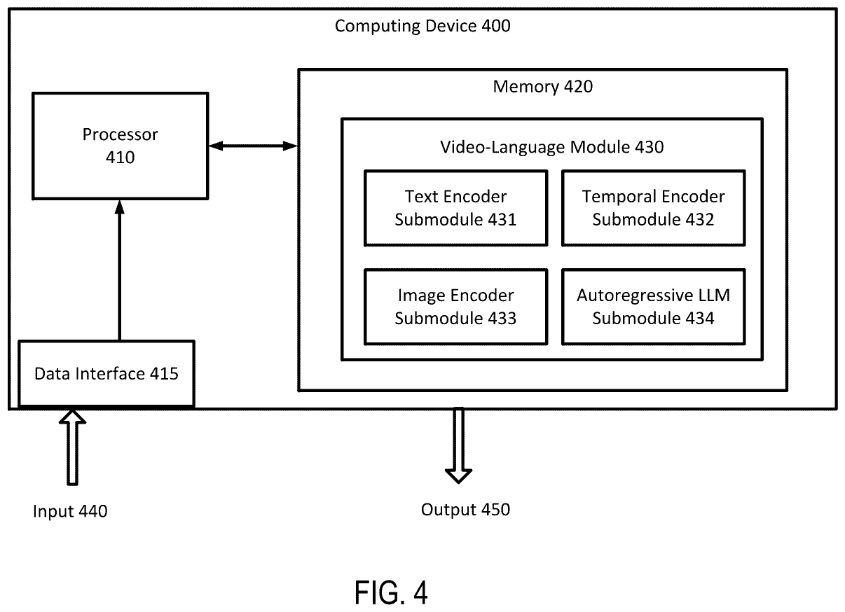

FIG. 4 is a simplified diagram illustrating a computing device implementing the multimodal model framework described in FIG. 1, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for Video-language module 430 that may be used to implement and/or emulate the systems and models, and/or to implement any of the methods described further herein. Video-language module 430 may receive input 440 such as an input training data (e.g., video, text user query, text caption, image/caption pairs, instructions, etc.) via the data interface 415 and generate an output 450 which may be a text output.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a text user query, an input video, from a user via the user interface.

In some embodiments, the Video-language module 430 is configured to train and/or perform inference as described herein. The Video-language module 430 may further include a text encoder submodule 431 (e.g., similar to 208 in FIG. 2), a temporal encoder submodule 432 (e.g., similar to 210 in FIG. 2), an image encoder submodule 433 (e.g., similar to image encoders 205a-n in FIG. 2) and an autoregressive LLM submodule 434 (e.g., similar to 220 in FIG. 2).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the Video-language module 430 described in FIG. 4, according to some embodiments. In some embodiments, the Video-language module 430 and/or one or more of its submodules 431-434 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5A), such as text and images. The number of nodes (neurons) in the input layer 541 may be determined by the dimensionality of the input data (e.g., the length of a vector of the text and/or images). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 4, the Video-language module 430 receives an input 440 of text and images and transforms the input into an output 450 of a text response. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the Video-language module 430 and/or one or more of its submodules 431-434 may comprise the transformative neural network structure of layers of neurons, and weights and activation functions describing the non-linear transformation at each neuron. Such a neural network structure is often implemented on one or more hardware processors 510, such as a graphics processing unit (GPU).

In one embodiment, the Video-language module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the Video-language module 430 and its submodules 431-434 may be implemented by hardware, software and/or a combination thereof. For example, the Video-language module 530 and its submodules 531-234 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the video-language module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the video-language module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the video-language module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the Video-language module 430 and its submodules 431-434 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the Video-language module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based Video-language module 430 and one or more of its submodules 431-434 may be trained by iteratively updating the underlying parameters (e.g., weights 551, 552, etc., bias parameters and/or coefficients in the activation functions 561, 562 associated with neurons) of the neural network based a loss function. For example, during forward propagation, the training data such as image/caption pairs are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding ground truth output text tokens) from the training data, to compute a loss function that measures the discrepancy between the predicted output and the expected output. For example, the loss function may be cross entropy, MMSE, etc. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based Video-language module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, Video-language module 430 and its submodules 431-434 may be housed at a centralized server (e.g., computing device 500) or one or more distributed servers. For example, one or more of Video-language module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen images and text.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in large multimodal models.

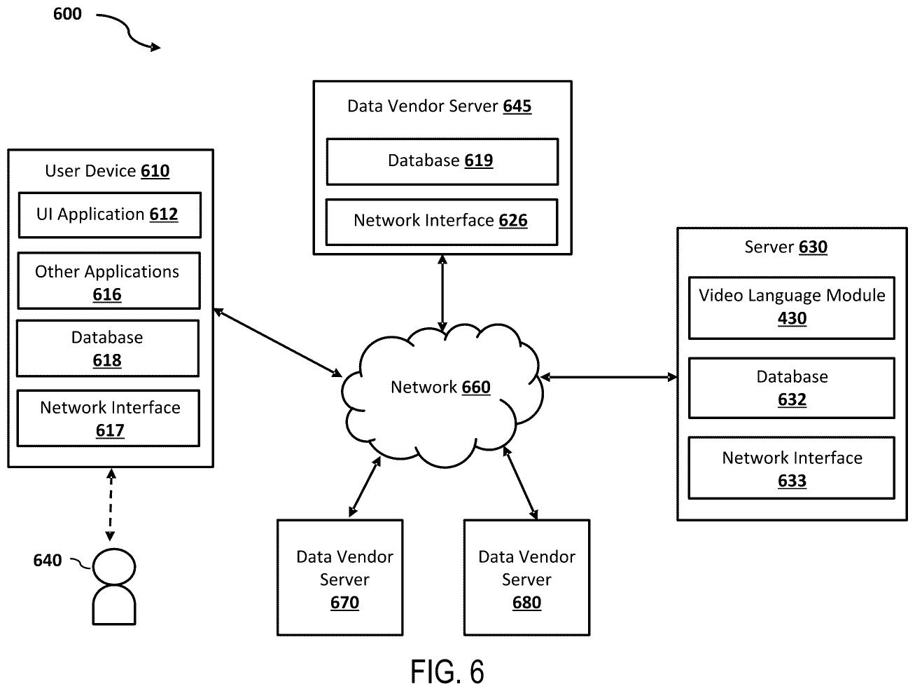

FIG. 6 is a simplified block diagram of a networked system 600 suitable for implementing the multimodal model framework described in FIGS. 1-2B and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the Video-language module 230 at server 630. In at least one embodiment, a user operating user device 610 may enter a user utterance, e.g., via text or audio input, such as a question, uploading a document, and/or the like via the UI application 612. Such user utterance may be sent to server 630, at which Video-language module 230 may generate a response via the process described in FIGS. 1-2B. The Video-language module 230 may thus cause a display of a response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view responses.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including images and text to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the Video-language module 430 and its submodules described in FIG. 4. In some implementations, Video-language module 430 may receive data from database 619 at the data vendor server 645 via the network 660 to generate responses. The generated responses may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the Video-language module 230. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Word Flow

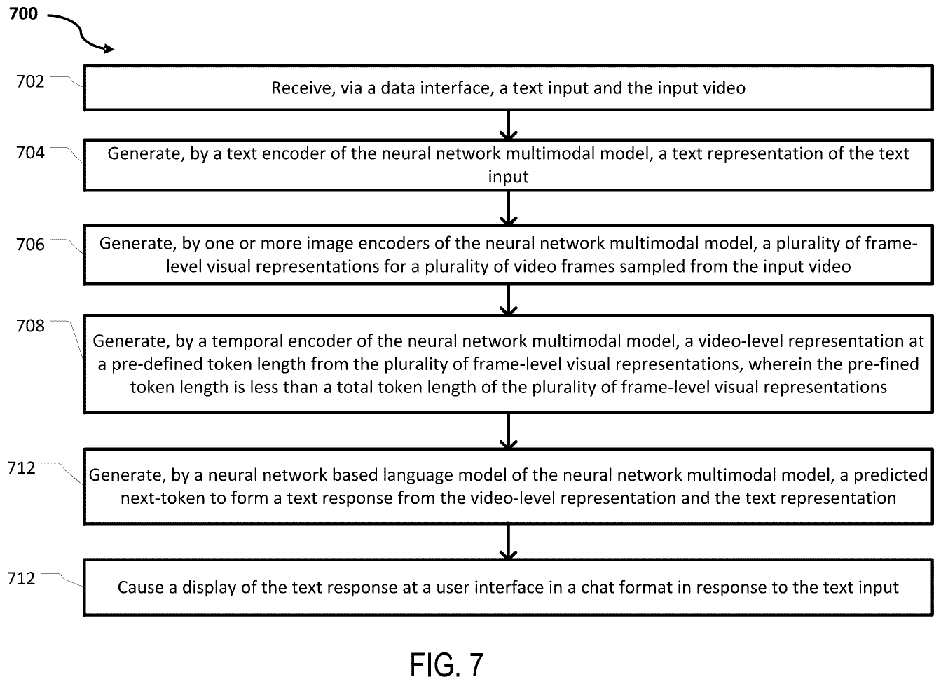

FIG. 7 is an example logic flow diagram illustrating a method of perform a vision-language task by a neural network multimodal model in response to an input video shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the LMM module 430 that performs training and/or inference of an LMM.

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a data interface (e.g., 415 in FIG. 4, or network interface 633 in FIG. 6) may receive a text input (e.g., similar to 106 in FIG. 1, 206 in FIG. 2) and the input video (e.g., similar to 102 in FIG. 1).

At step 704, a text encoder (e.g., 208 in FIG. 2) of the neural network multimodal model (e.g., 110 in FIGS. 1-2) may generate a text representation of the text input.

At step 706, one or more image encoders (e.g., 205a-n in FIG. 2) of the neural network multimodal model may generate a plurality of frame-level visual representations for a plurality of video frames (e.g., 202a-n in FIG. 2) sampled from the input video. For example, raw vision tokens from each of the one or more image encoders (e.g., 205a-n in FIG. 2) may be downsampled, by one or more token samplers, to obtain a reduced number of tokens for each of the plurality of frame-level visual representations.

At step 708, a temporal encoder (e.g., 210 in FIG. 2) of the neural network multimodal model may generate a video-level representation at a pre-defined token length from the plurality of frame-level visual representations. For example, the pre-fined token length is less than a total token length of the plurality of frame-level visual representations.

For example, in one implementation, the temporal encoder may sum one or more per-frame tokens (e.g., 302 in FIG. 3A) from the plurality of frame-level visual representations over a time span of the input video, as described in relation to FIG. 3A.

For example, in one implementation, the temporal encoder may comprise a Transformer-based structure (e.g., 310 in FIG. 3B) that selects one or more last per-frame tokens (e.g., 311-313 in FIG. 3B) from a flattened sequence of tokens (e.g., 302 in FIG. 3B) representing the plurality of frame-level visual representations over a time span of the input video, as described in relation to FIG. 3B.

For example, in one implementation, the temporal encoder may perform a learnable selection of one or more per-frame tokens from the plurality of frame-level visual representations over a time span of the input video. The learnable selection is updated during backpropagation of the neural network multimodal model at training, as described in relation to FIG. 3C.

For example, in one implementation, the temporal encoder combines one or more time-stamped positional encodings, indicative of frame indices in a matrix (e.g., 302 in FIG. 3D) of per-frame tokens representing the plurality of frame-level visual representations over a time span of the input video, into output tokens (e.g., 311-313 in FIG. 3D), as described in relation to FIG. 3D.

At step 710, a neural network based language model (e.g., LLM 210 in FIG. 2) of the neural network multimodal model may generate a predicted next token (e.g., 218 in FIG. 2) to form a text response (e.g., 108 in FIG. 1) from the video-level representation and the text representation.

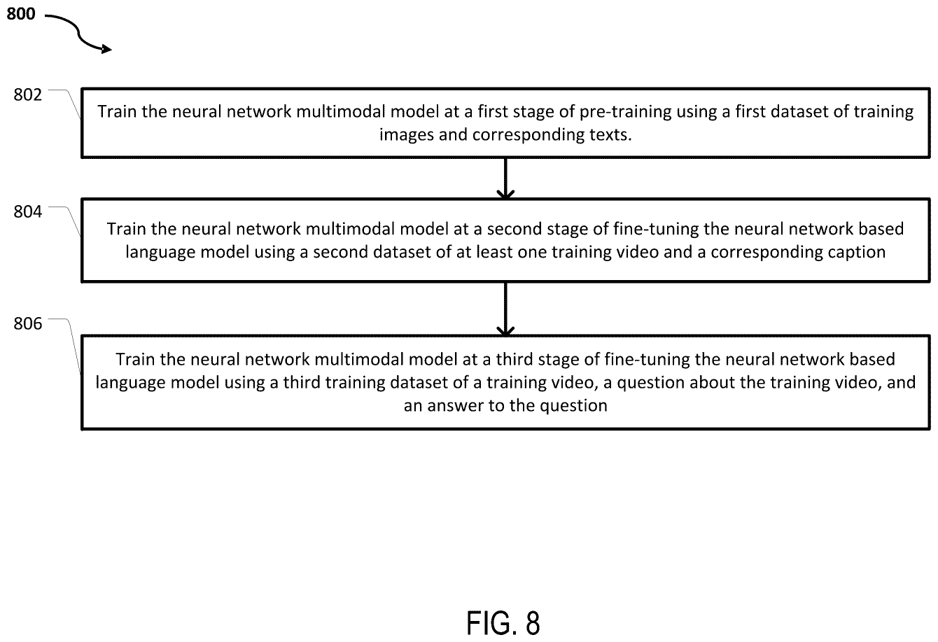

FIG. 8 is an example logic flow diagram illustrating a method of training the neural network multimodal model to perform a video-language task shown in FIGS. 1-6, in response to multiple input images, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the LMM module 430 that performs training and/or inference of an LMM.

As illustrated, the method 800 includes a number of enumerated steps, but aspects of the method 800 may include additional steps before, after, and in between the enumerated steps. In some aspects, one or more of the enumerated steps may be omitted or performed in a different order.

In one embodiment, method 800 may train the neural network multimodal model (e.g., 110 in FIGS. 1-2) by updating the neural network based language model (e.g., 220 in FIG. 2) based on a loss objective via backpropagation while keeping the one or more image encoders (e.g., 205a-n in FIG. 2) unchanged.

At step 802, the training of the neural network multimodal model may comprise a first stage of pre-training using a first dataset of training images and corresponding texts, e.g., image caption pretraining. In some implementations, the neural network multimodal model may at least partially inherit weights from the trained and finetuned neural network multimodal model trained to process multiple images from co-pending U.S. nonprovisional application Ser. No. ______ (attorney docket no. 70689.362US01), filed on the same day, which is hereby expressly incorporated by reference herein in its entirety.

At step 804, the training of the neural network multimodal model may comprise a second stage of fine-tuning the neural network based language model using a second dataset of at least one training video and a corresponding caption, e.g., video caption pretraining. For example, the neural network multimodal model may be trained on LLaVA-Hound-DPO's video caption data, featuring over 900k video captions. Instead of directly using the text captions provided in LLaVA-Hound-DPO, the caption may be rephrased by GPT-40 to rephrase such text captions. At this stage of pretraining, sampled video frames (e.g., 202a-n) and corresponding caption (e.g., 206) may be fed into the neural network multimodal model in a similar manner as shown in FIG. 2 such that LLM 220 may generate a predicted next token 218 that supposedly reconstruct the video tokens corresponding to video frames 202a-n and/or text tokens corresponding to caption 206. The reconstructed text tokens may then be compared with the text tokens from text encoder 208 to compute a cross-entropy loss.

At step 806, the training the neural network multimodal model may comprise a third stage of fine-tuning the neural network based language model using a third training dataset of a training video, a question about the training video, and an answer to the question, e.g., video instruction tuning. For example, this stage of fine-tuning may use a mix of video question-answering datasets, including VideoChatGPT's 99k-sample video instruction tuning data (Maaz et al., Video-chatgpt: Towards detailed video understanding via large vision and language model, in Proceedings of the 62nd Annual Meeting of the Association for Computational Linguistics, 2024), along with the training splits of the MSVD-QA and MSRVTT-QA (described in Xu et al., Video question answering via gradually refined attention over appearance and motion, in ACM Multimedia, 2017), ActivityNet-QA (Yu et al., Activitynet-qa: A dataset for understanding complex web videos via question answering, in Proceedings of the AAAI Conference on Artificial Intelligence, volume 33, pp. 9127-9134, 2019), TGIF-QA (Jang et al., TGIF-QA: Toward spatio-temporal reasoning in visual question answering, in Proceedings of the IEEE conference on computer vision and pattern recognition, pp. 2758-2766, 2017), and NEXT-QA (Xiao et al., Next-QA: Next phase of question-answering to explaining temporal actions, in Proceedings of the IEEE/CVF conference on computer vision and pattern recognition, pp. 9777-9786, 2021) datasets, which contain 30k, 149k, 32k, 71k, and 34k samples, respectively. For TGIF-QA, the training data associated with the Repeating Action and State Transition tasks may be involved. At this stage of fine-tuning, both open-ended and multiple-choice video QA formats for TGIF-QA and NExT-QA are used. For the open-ended video QA training data sourced from the MSVD-QA, MSRVTT-QA, TGIF-QA, and NEXT-QA training sets, GPT-3.5 may be used to rephrase the original single-word or single-phrase answer into a natural language sentence, providing the question in the LLM prompt context. For open-ended TGIF-QA and NEXT-QA, the sample size may be doubled by using both the original short-phrase answers and the rephrased sentence-based answers. In addition, a filtered version of the Mira caption dataset (Ju et al., Miradata: A large-scale video dataset with long durations and structured captions, arXiv 2407.06358, 2024) can be included for video instruction tuning, e.g., both video question-answering and video captioning are used for final training.

For example, at this stage of finetuning, sampled video frames (e.g., 202a-n) and a corresponding training question (e.g., 206) may be fed into the neural network multimodal model in a similar manner as shown in FIG. 2 such that LLM 220 may generate a predicted next token 218 that supposedly represent an answer to the training question. The predicted text tokens of the answer may then be compared with the actual answer in the training data to compute a cross-entropy loss.

Method 800 may be performed by 8×H100 GPUs. For the video caption pretraining at step 804, a batch size of 16 per GPU, 500 warmup steps, and the learning rate of 2e-5 with the cosine decay, and the model may be trained for 1 epoch. The video QA sft (i.e., instruction tuning) was done with the batch size of 4 per GPU, 500 warmup steps, and the learning rate of 1e-5 with the cosine decay. The model may be trained for 1 epoch in this case as well. The entire training (combining both video pretraining and the sft) takes around 12 hours, confirming the efficiency of the neural network based model.

In one embodiment, methods 700-800 may be applied to an AI agent in a variety of other vision-language related tasks. For example, in healthcare, the text input may comprise a doctor's inquiry to identify particular patterns and the video input may comprise an ultrasound imaging recoding. The neural network based language model may thus be trained using method 800 to generate a diagnostic result, such that a medical professional may associate a treatment plan with the AI generated diagnostic result. For another example, in autonomous driving, the text input may comprise an inquiry relating to a surrounding of an autonomous vehicle, and the video input may comprise a recording of, or live video streaming capturing the surroundings. The neural network based language model may thus be trained using method 800 and then perform method 700 to generate a control command to be sent to the control mechanism of the autonomous vehicle to steer a direction and driving of the vehicle.

### Example Data Experiments

Example data experiments may be conducted taking input videos with the input resolution of 384×384, using SigLIP encoder to map it to 729 tokens per frame with the channel size 1152. The Perceiver-Resampler is implemented with multiple cross-attention layers with the same channel dim, which is then given to the temporal encoder (e.g., 210 in FIG. 2). TokenLearner serving as the spatio-temporal attentional pooling was implemented using a MLP as the attention function. The size of its inner dim was the number of target tokens×2. The grouped TTM serving as the sequential model temporal encoder was implemented using 4 Transformer layers (with the channel dim of 1152) as the processor module while using TokenLearners for read/write modules. Memory size was set to N×4=512 tokens total. The resulting 16˜128 tokens are mapped to the text embedding with the channel dimension of 3072, before given to the LLM (e.g., 220 in FIG. 2).

Experiments measuring video question-answering accuracies on multiple public datasets may be conducted. This includes open-ended answer generation tasks like MSVD-QA, as well as multiple choice questions like NEXT-QA. Table 1 compare open-ended question answering accuracies of BLIP-3-Video against reported numbers of other models. Four commonly used public datasets, MSVD-QA, MSRVTT-QA, ActivityNet-QA, and TGIF-QA, following standard VideoLLM evaluation settings, and also the model size as well as the number of visual tokens in the table.

TABLE 1

| Method | Size | #tokens | MSVD-QA | MSRVTT-QA | ActivityNet-QA | TGIF-QA |
|---|---|---|---|---|---|---|
| VideoChat | 7B | 32 | 56.3/2.8 | 45.0/2.5 | —/2.2 | 34.4/2.3 |
| Video-LLaMA | 7B | 32 | 51.6/2.5 | 29.6/1.8 | 12.4/1.1 | —/— |
| Video-ChatGPT | 7B | 264+ | 64.9/3.3 | 49.3/2.8 | 34.2/2.8 | 51.4/3.0 |
| Chat-UniVi | 7B | 112 | 69.3/3.7 | 55.0/3.1 | 46.1/3.3 | 69.0/3.8 |
| LLaMA-VID | 7B | 32 | 69.7/3.7 | 57.7/3.2 | 47.4/3.3 | — |
| LLaMA-VID | 13B | 32 | 70.0/3.7 | 58.9/3.3 | 47.5/3.3 | — |
| Video-LLaVA | 7B | 2048 | 71.8/3.9 | 59.2/3.5 | 45.3/3.3 | 70.0/4.0 |
| MiniGPT4-Video | 7B | 2880+ | 73.9/4.1 | 59.7/3.3 | 46.3/3.4 | 72.2/4.1 |
| PLLaVA | 7B | 576+ | 76.6/4.1 | 62.0/3.5 | 56.3/3.5 | 77.5/4.1 |
| SlowFast-LLaVA Xu et al. | 7B | 3680 | 79.1/4.1 | 65.8/3.6 | 56.3/3.4 | 78.7/4.2 |
| LLaVA-Hound-DPO Zhang et al. | 7B | 2048 | 80.7/4.1 | 70.2/3.7 | —/— | 61.4/3.5 |
| LLaVA-OneVision* | 7B | 1568 | 72.9/3.9 | 57.8/3.4 | 55.3/3.6 | 41.1/3.1 |
| Tarsier | 7B | 4608+ | 77.0/4.1 | 62.0/3.5 | 59.5/3.6 | 79.2/4.2 |
| Tarsier* | 7B | 4608 | 74.4/4.0 | 59.1/3.4 | 54.3/3.5 | —/— |
| PLLaVA | 34B | 576+ | 79.9/4.2 | 68.7/3.8 | 60.9/3.7 | 80.6/4.3 |
| LLaVA-NeXT-Video* | 32B | 1152 | 73.6/4.0 | 56.8/3.4 | 58.4/3.6 | 73.5/4.1 |
| Tarsier | 34B | 4608+ | 80.3/4.2 | 66.4/3.7 | 61.6/3.7 | 82.5/4.4 |
| Tarsier* | 34B | 4608 | 79.3/4.1 | 62.2/3.5 | 61.5/3.7 | —/— |
| BLIP-3-Video | 4B | 32 | 77.7/4.2 | 60.0/3.6 | 55.7/3.5 | 76.5/4.3 |
| BLIP-3-Video | 4B | 128 | 77.9/4.3 | 59.7/3.6 | 56.9/3.6 | 77.1/4.3 |

It is observed that despite its smaller size (i.e., 4B vs. 7B or 34B), the BLIP-3-video model (e.g., 110 in FIGS. 1-2) is obtaining superior or comparable performance. With the temporal encoder, BLIP-3-Video was able to retain the performance with much fewer tokens. The results suggest that not too many visual tokens are really necessary to be successful on these open-ended question answering benchmarks, as long as we have a carefully designed temporal encoder.

In addition, BLIP-3-Video's ability to solve multiple choice questions (MCQ) may be examined. Table 2 shows the results on NEXT-QA. Due to the nature of its questions requiring understanding of multiple frames, many prior models use quite a bit of tokens.

TABLE 2

| Method | Size | #tokens | NExT-QA |
|---|---|---|---|
| LangRepo | 7B | 3136+ | 54.6 |
| LangRepo | 12B | 3136+ | 60.9 |
| Tarsier | 7B | 4608+ | 71.6 |
| LLoVi | 157B | 1000 s | 67.7 |
| IG-VLM | 34B | 1536+ | 70.9 |
| VideoAgent | GPT-4 | 2091+ | 71.3 |
| VideoTree | GPT-4 | 3978+ | 73.5 |
| Tarsier | 34B | 4608+ | 79.2 |
| BLIP-3-Video | 4B | 32 | 76.4 |
| BLIP-3-Video | 4B | 128 | 77.1 |

For instance, GPT-4 uses a minimum of 255 tokens per frame. It is interesting that BLIP-3-Video achieves comparable accuracy while representing the entire video with only 32 (or 128) tokens evaluate our model on the video captioning task by comparing it against state-of-the-art models on the test splits of MSVD-Caption and MSRVTT-Caption, as well as a custom evaluation split from the Mira dataset. For the Mira dataset, the data experiments randomly selected 6,000 samples from the full, filtered data to create the evaluation split, with the remainder used for training. We employed Video-ChatGPT's LLM evaluation, specifically using GPT-3.5 to compare model-predicted captions with ground truth captions. The LLM assesses accuracy by checking if the predicted caption matches the ground truth, and assigns a score on a scale of 0 to 5 for each sample.

Table 6 demonstrates the evaluation results. All three models were provided with 8 frames per video, and consistent visual input and prompts were ensured across the models. BLIP-3-Video consistently outperforms LLaVA-OneVision-7B and Tarsier-7B across all three video captioning benchmarks, with particularly notable improvements on the Mira video captioning task.

TABLE 6

| | | # | MSVD- | MSRVTT- | Mira- |
|---|---|---|---|---|---|
| Method | Size | tokens | Cap | Cap | Cap |
| LLaVA-OneVision | 7B | 1152 | 61.62/3.31 | 38.60/2.71 | 48.83/3.10 |
| Tarsier | 7B | 4608 | 62.26/3.37 | 40.27/2.77 | 40.55/2.87 |
| BLIP-3-Video | 4B | 32 | 63.59/3.38 | 42.06/2.82 | 80.67/3.96 |
| BLIP-3-Video | 4B | 128 | 64.17/3.41 | 43.05/2.85 | 81.13/3.97 |
| BLIP-3-Video | 4B | 128 | 69.50/3.52 | 50.45/2.98 | 81.76/4.00 |
| (captioning-only | | | | | |
| model) | | | | | |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of perform a vision-language task by a neural network multimodal model in response to an input video, the method comprising:
receiving, via a data interface, a text input and the input video;
generating, by a text encoder of the neural network multimodal model, a text representation of the text input;
generating, by one or more image encoders of the neural network multimodal model, a plurality of frame-level visual representations for a plurality of video frames sampled from the input video;
generating, by a temporal encoder of the neural network multimodal model, a video-level representation at a pre-defined token length from the plurality of frame-level visual representations, wherein the pre-fined token length is less than a total token length of the plurality of frame-level visual representations; and
generating, by a neural network based language model of the neural network multimodal model, a predicted next-token to form a text response from the video-level representation and the text representation.

2. The method of claim 1, further comprising:
downsampling, by one or more token samplers, raw vision tokens from each of the one or more image encoders to obtain a reduced number of tokens for each of the plurality of frame-level visual representations.

3. The method of claim 1, wherein the temporal encoder sums one or more per-frame tokens from the plurality of frame-level visual representations over a time span of the input video.

4. The method of claim 1, wherein the temporal encoder comprises a Transformer-based structure that selects one or more last per-frame tokens from a flattened sequence of tokens representing the plurality of frame-level visual representations over a time span of the input video.

5. The method of claim 1, wherein the temporal encoder performs a learnable selection of one or more per-frame tokens from the plurality of frame-level visual representations over a time span of the input video, wherein the learnable selection is updated during backpropagation of the neural network multimodal model at training.

6. The method of claim 1, wherein the temporal encoder combines one or more time-stamped positional encodings, indicative of frame indices in a flattened sequence of per-frame tokens representing the plurality of frame-level visual representations over a time span of the input video, into output tokens.

7. The method of claim 1, further comprising:
training the neural network multimodal model by updating the neural network based language model based on a loss objective via backpropagation while keeping the one or more image encoders unchanged.

8. The method of claim 7, wherein the training the neural network multimodal model comprises a first stage of pre-training using a first dataset of training images and corresponding texts.

9. The method of claim 8, wherein the training the neural network multimodal model comprises a second stage of fine-tuning the neural network based language model using a second dataset of at least one training video and a corresponding caption.

10. The method of claim 9, wherein the training the neural network multimodal model comprises a third stage of fine-tuning the neural network based language model using a third training dataset of a training video, a question about the training video, and an answer to the question.

11. A system of a vision-language task by a neural network multimodal model in response to an input video, the system comprising:
a data interface receiving a text input and the input video;
a memory storing a plurality of processor-executable instructions; and
one or more processors executing the plurality of processor-executable instructions to perform operations comprising:
generating, by a text encoder of the neural network multimodal model, a text representation of the text input;
generating, by one or more image encoders of the neural network multimodal model, a plurality of frame-level visual representations for a plurality of video frames sampled from the input video;
generating, by a temporal encoder of the neural network multimodal model, a video-level representation at a pre-defined token length from the plurality of frame-level visual representations, wherein the pre-fined token length is less than a total token length of the plurality of frame-level visual representations; and
generating, by a neural network based language model of the neural network multimodal model, a predicted next-token to form a text response from the video-level representation and the text representation.

12. The system of claim 11, wherein the operations further comprise:
downsampling, by one or more token samplers, raw vision tokens from each of the one or more image encoders to obtain a reduced number of tokens for each of the plurality of frame-level visual representations.

13. The system of claim 11, wherein the temporal encoder sums one or more per-frame tokens from the plurality of frame-level visual representations over a time span of the input video.

14. The system of claim 11, wherein the temporal encoder comprises a Transformer-based structure that selects one or more last per-frame tokens from a flattened sequence of tokens representing the plurality of frame-level visual representations over a time span of the input video.

15. The system of claim 11, wherein the temporal encoder performs a learnable selection of one or more per-frame tokens from the plurality of frame-level visual representations over a time span of the input video, wherein the learnable selection is updated during backpropagation of the neural network multimodal model at training.

16. The system of claim 11, wherein the temporal encoder combines one or more time-stamped positional encodings, indicative of frame indices in a flattened sequence of per-frame tokens representing the plurality of frame-level visual representations over a time span of the input video, into output tokens.

17. The system of claim 11, wherein the operations further comprise:
training the neural network multimodal model by updating the neural network based language model based on a loss objective via backpropagation while keeping the one or more image encoders unchanged.

18. The system of claim 17, wherein the operation of training the neural network multimodal model comprises:
a first stage of pre-training using a first dataset of training images and corresponding texts;
a second stage of fine-tuning the neural network based language model using a second dataset of at least one training video and a corresponding caption; and
a third stage of fine-tuning the neural network based language model using a third training dataset of a training video, a question about the training video, and an answer to the question.

19. A non-transitory processor-readable medium storing a plurality of processor-executable instructions of perform a vision-language task by a neural network multimodal model in response to an input video, the instructions being executed by one or more processors to perform operations comprising:
receiving, via a data interface, a text input and the input video;
generating, by a text encoder of the neural network multimodal model, a text representation of the text input;
generating, by one or more image encoders of the neural network multimodal model, a plurality of frame-level visual representations for a plurality of video frames sampled from the input video;
generating, by a temporal encoder of the neural network multimodal model, a video-level representation at a pre-defined token length from the plurality of frame-level visual representations, wherein the pre-fined token length is less than a total token length of the plurality of frame-level visual representations; and
generating, by a neural network based language model of the neural network multimodal model, a predicted next-token to form a text response from the video-level representation and the text representation.

20. The medium of claim 19, wherein the operation of training the neural network multimodal model comprises:
a first stage of pre-training using a first dataset of training images and corresponding texts;
a second stage of fine-tuning the neural network based language model using a second dataset of at least one training video and a corresponding caption; and
a third stage of fine-tuning the neural network based language model using a third training dataset of a training video, a question about the training video, and an answer to the question.
